(19) United States
(12) Patent Application Publication
(10) Pub. No.: US 2011/0055077 A1
(43) Pub. Date: Mar. 3, 2011

(54) PORTABLE CONSUMER DEVICE WITH FUNDS TRANSFER PROCESSING

(76) Inventors: Susan French, Foster City, CA (US); John Tullis, San Francisco, CA (US)

(21) Appl. No.: 12/873,961

(22) Filed: Sep. 1, 2010

Related U.S. Application Data
(60) Provisional application No. 61/239,343, filed on Sep. 2, 2009.

(51) Int. Cl. G06Q 40/00

(52) U.S. Cl. 705/39

(57) ABSTRACT

A portable consumer device with funds transfer processing systems and methods are disclosed. A sending entity may initiate a money transfer from one portable consumer device, such as a credit or debit card, to another portable consumer device through a money transfer system. A sending entity may initiate a payment request and the money transfer system may prompt the sending entity to use one of a plurality of payment account identifiers it possess. A recipient entity is defined by either an alias or a recipient entity personal account identifier. Additionally, an unregistered recipient entity may return a claim code to the money transfer system to claim a money transfer.

### CROSS-REFERENCES TO RELATED APPLICATIONS

The present non-provisional application claims the benefit under 35 U.S.C. §119(e) of U.S. Provisional Patent Application No. 61/239,343, entitled “Mobile Device With Funds Transfer Processing,” filed Sep. 2, 2009, the entire disclosure of which is incorporated herein by reference in its entirety for all purposes.

### BACKGROUND

Currently, a recipient entity of a credit card or debit card transaction, such as a merchant, possesses a merchant bank account to receive payments. A merchant bank account is acquired through an application process which may entail one time application fees and time delays for application approval. The cost, time, and burden of the application process make a merchant bank account an unsuitable option for most individuals wishing to conduct money transfers.

Companies such as PayPal support money transfers where a merchant bank account is not required. However, PayPal does not support receiving payments directly from a credit or debit card. Rather, PayPal money transfers are funded from a PayPal account. Moreover, the received payments are deposited into a PayPal account rather than into a recipient entity's bank account or an account associated with a recipient entity's credit or debit card. The reliance on PayPal accounts to conduct money transfers foregoes the convenience and advantages of existing payment card networks and infrastructure.

Embodiments of the invention address these and other problems, individually and collectively.

### BRIEF SUMMARY

Embodiments of the invention disclosed herein include systems, technical architecture of the systems, and methods for a portable consumer device with funds transfer processing. A portable consumer device with funds transfer processing system can be implemented using one or more computer apparatuses and databases.

One embodiment of the invention is directed to a system and method for receiving a payment request message from a sending entity, determining if a plurality of personal account identifiers are associated with the sending entity and if a plurality of personal account identifiers are associated with the sending entity then providing the plurality of personal account identifiers to the sending entity and receiving a single personal account identifier from the sending entity, wherein the personal account identifiers are associated with a portable consumer device, receiving a recipient entity identifier and transfer details from the sending entity, wherein the recipient entity identifier is an alias or a personal account number of a recipient entity and the transfer details comprise a transfer amount, receiving a portable consumer device verification code from the sending entity, generating a reference code from the one personal account identifier and the recipient entity identifier and providing the reference code to the sending entity.

Another embodiment of the invention is directed to a method for communicating a value transfer deposit message to a recipient entity issuer and a value transfer debit message to a sending entity issuer.

A further embodiment of the invention is directed to a method for determining that the recipient entity identifier is an unregistered alias and providing a claim code to the recipient entity wherein the unregistered alias is registered upon receiving from the recipient entity the claim code and personal account information associated with a personal account of the recipient entity and a value transfer deposit message is sent to a recipient entity issuer and a value transfer debit message is sent to a sending entity issuer after the recipient entity registers.

Another embodiment of the invention is directed to a method for processing a transfer fee with the transfer amount so that the sending entity is debited the transfer amount plus the transfer fee and sending a value transfer deposit message is sent to a recipient entity issuer and a value transfer debit message is sent to a sending entity issuer after the recipient entity registers.

Another embodiment of the invention is directed to a method for processing a payment request message via short messaging service and wherein the payment request message is parsed for a sending entity phone number and a recipient entity identifier, and further wherein it is determined whether the plurality of personal account identifiers is associated with the sending entity phone number.

### BRIEF DESCRIPTION OF THE DRAWINGS

FIG. 1 is a portable consumer device with funds transfer processing system, according to an example embodiment.

FIG. 2 is a data model of a user profile in a portable consumer device with funds transfer processing system, according to an example embodiment.

FIG. 3 is process flow of a web based money transfer process, according to an example embodiment.

FIG. 4 is a process flow of a short messaging service and interactive voice response based money transfer, according to an example embodiment.

FIG. 5 is a process flow of an agent supported money transfer, according to an example embodiment.

FIG. 6 is a claim money transfer process, according to an example embodiment.

FIG. 7 is a diagram of a computer apparatus, according to an example embodiment.

### DETAILED DESCRIPTION

Embodiments of the invention are directed to systems, architectures of the systems, and methods conducting a funds transfer process with portable consumer devices.

In certain embodiments, the funds transfer processing system supports money transfers between portable consumer devices, such as credit and debit cards. A money transfer is a transaction that transfers funds/money from one account associated with a portable consumer device to another account associated with another portable consumer device. In an example embodiment, a money transfer may transfer funds from one credit/debit card account to another credit/debit card account. In another embodiment, the accounts may be associated with a mobile device, such as a mobile phone. In an example embodiment, the accounts may be associated with a payment processing network and/or held by issuing entities or banks.

A portable consumer device with funds transfer processing system can provide money transfer services. Money transfer services may comprise customer enrollment, transaction initiation, transaction processing, transaction receipt, transaction notification, risk management, and reporting services. Such services may be provided to cardholders, portable consumer device holders (e.g., cardholders), and participating banks. Money transfers may be enabled via the web, via short messaging service (“SMS”)/interactive voice response (“IVR”), via mobile phone, via online systems, and at participating bank locations. A money transfer system is an entity of the portable consumer device with funds transfer processing system that may interact with issuers and other entities to facilitate money transfers.

The money transfer system facilitates money transfers between portable consumer devices. A portable consumer device may be a credit card, a debit card, a mobile phone, a pre-paid card, or any portable device capable of funding a money transfer. In an example embodiment, portable consumer devices may be associated with sensitive information, such as a credit card expiration date, a CVV2, or a personal account number (“PAN”), also commonly referred to as a permanent account number or a primary account number. In an example embodiment, aliases may be used to identify a sending entity or a recipient entity in a money transfer to preserve privacy and reduce the likelihood of fraud associated with sharing sensitive information. In an example embodiment, an alias may be an alpha-numeric value, such as a username. In a further embodiment, an alias may be a verifiable value, such as a phone number or an email address. For example, a money transfer transaction may send money to the alias “ted@ted.com” rather than a credit card or bank account number. Aliases may be unique across the money transfer system and may be associated with one or more portable consumer devices. The money transfer system supports money transfers without the need of the recipient entity to possess a merchant bank account.

The money transfer system may be operated by a payment processing network and may provide money transfer services and functionality to registered banks, portable consumer device issuing entities, and other issuers. An issuer may register with the money transfer system to enable money transfer services for their account holders. Issuers may customize the scope of money transfer services the money transfer system provides for their account holders, such as supporting money transfers only through certain channels, including branding customization options (e.g., including issuer branding on hosted pages), customized risk tolerances (e.g., transactional value, velocity limits, etc).

Account holders of an issuer may register with the money transfer system directly or through an enrollment page hosted by their issuer. In addition, an account holder may access the money transfer system through their alias and access money transfer services for a plurality of portable consumer devices, where each portable consumer device may be issued from a different issuer which may provide different money transfer services. In an example embodiment, an account holder may also have more than one alias.

The money transfer system may support additional services, such as account holder/user authentication, profile management, and customer service support.

Embodiments of the invention are directed to systems and methods supporting a money transfer when a sending account holder (“sending entity”) is accessing the money transfer system using an alias that may have more than one portable consumer device associated with it. Embodiments of the invention also manage the transfer of money when the receiving account holder (“the recipient entity”) is not registered with the money transfer system. The money transfer may be initiated online, such as on a webpage, or using SMS/IVR, via phone, or through an agent at a participating bank.

In an example embodiment, an embodiment of the invention processes a money transfer after a sending entity, registered with the money transfer system, has authenticated with the money transfer system. The sending entity initiates a money transfer by sending a payment request message to the money transfer system. Upon receiving the payment request message, the money transfer system determines how many personal account identifiers are associated with the sending entity. A personal account identifier is an identifier that is associated with the sending entity portable consumer device. A personal account identifier may be a PAN associated with a credit or debit card, a mobile number or account number of a mobile account, or another account identifier. In an example embodiment, the payment request message may comprise a sending entity identifier, such as a sending entity alias or personal account identifier. The sending entity alias may be used to determine if a plurality of personal account identifiers are associated with the sending entity. In an example embodiment, one portable consumer device may be associated with one and only one personal account identifier. In a further embodiment, a personal account identifier can be used to determine if other personal account identifiers are also associated with the same sending entity.

If the money transfer system determines that only a single personal account identifier is associated with the sending entity, then the portable consumer device associated with the single personal account identifier is used to fund the money transfer. However, if a plurality of personal account identifiers is associated with the sending entity, then the money transfer system will send the plurality of personal account identifiers to the sending entity and prompt the sending entity to select one of the plurality of personal account identifiers. The sending entity may receive the plurality of personal account identifiers and select one, and communicate that selection to the money transfer system. Upon receiving the sending entity's selection of one of the plurality of personal account identifiers, the money transfer system continues processing the money transfer using the portable consumer device associated with the selected one personal account identifier to fund the money transfer.

The money transfer system may prompt the sending entity for, and the sending entity may provide to the money transfer system, a recipient entity identifier. The recipient entity identifier may be an alias, a personal account identifier, a PAN, a mobile number, or other identifier. The money transfer system may receive and analyze the recipient entity identifier to determine the recipient entity. If the money transfer system determines that the recipient entity identifier is a registered alias then the alias is used to lookup and derive the personal account identifier of the recipient entity. If the recipient entity has more than one personal account identifier associated with the alias, then a designated default personal account identifier is used. If the money transfer system determines that the recipient entity identifier is a personal account identifier, then that personal account identifier is used. In an example embodiment, various security checks may be conducted on the personal account identifier, such as a modulus ten digit check. The determined personal account identifier of the recipient entity is then used to detect the recipient entity portable consumer device to which money may be deposited. If the recipient entity identifier is an unregistered alias, then the money transfer continues and the recipient entity personal account identifier is determined at a later process.

The money transfer system may prompt the sending entity for, and the sending entity may provide, transfer details to the money transfer system. Transfer details may comprise a transfer amount and currency. The transfer details may also comprise a schedule for payment. In an example embodiment, the money transfer system may analyze the transfer details to calculate fees and foreign exchange rates. Ways to calculate foreign exchange rates can be found in U.S. Provisional Application 61/356,981, which is incorporated here in reference. In an example embodiment, fees and foreign exchange rates may be determined by analyzing the sending entity personal account identifier and the recipient entity personal account identifier to determine their default currency. In a further embodiment, the channel of the money transfer, such as web, SMS, etc, may also affect fee structures.

The money transfer system may present the calculated fees and other disclosures to the sending entity. If the sending entity accepts the fees then the money transfer continues. If the sending entity rejects the fees, then the money transfer process may restart. In an example embodiment, the sending entity also provides a portable consumer device verification code. A portable consumer device verification code may be a code associated with the portable consumer device, such as a CVV2 code. A CVV2 code, also known as a card verification code or card verification value, is a value that may be visible on the card and may be used by merchants and banks to ensure that the data stored on the magnetic stripe of a portable consumer device was generated by an issuing bank.

Upon receiving the portable consumer device verification code the money transfer system may generate a reference code for the money transfer and provide it to the sending entity, to signify a successful money transfer.

In an example embodiment, the recipient entity identifier may be an unregistered alias. In this scenario, the money transfer system generates a claim code and provides it to the sending entity, who in turn communicates it through other means to the recipient entity. In an example embodiment, the money transfer system may generate a claim code and provide it to the recipient entity. If the recipient entity alias is a phone number or email, instructions for using the claim code may be delivered through SMS or email, respectively. If the recipient entity registers with the money transfer system and returns the claim code, then the money transfer may continue and the recipient entity may receive the sending entity's funds. If the recipient entity does not register within a predetermined time frame, then the claim code may expire.

In a further embodiment, the money transfer system may transmit a value transfer debit message to the sending entity issuing bank and a value transfer deposit message to the recipient entity issuing bank. In an example embodiment, these transactions are an account funding transaction and an original credit transaction, respectively. The reference code may be sent after confirmation of both value transfer messages. The money transfer may also be conducted via SMS/IVR, mobile phone, or through an agent at a participating bank, with slightly different operations tailored to each respective channel.

Other specific examples of embodiments of the invention are described in further detail below.

### I. System

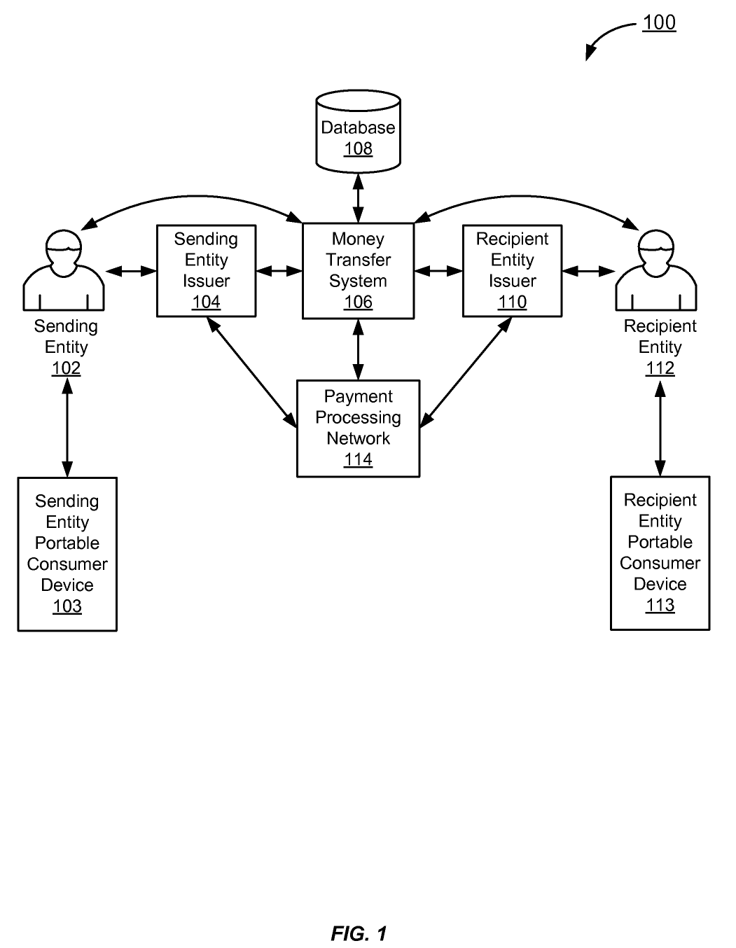

FIG. 1 is a portable consumer device with funds transfer processing system 100, according to an example embodiment. The portable consumer device with funds transfer processing system 100 comprises a sending entity 102, a sending entity portable consumer device 103, a sending entity issuer 104, a money transfer system 106, a database 108, a recipient entity issuer 110, a recipient entity 112, a recipient entity portable consumer device 113, and a payment processing network 114. Although one sending entity 102, one sending entity portable consumer device 103, one sending entity issuer 104, one money transfer system 106, one database 108, one recipient entity issuer 110, one recipient entity 112, and one recipient portable consumer device 113 are shown, there may be any suitable number of any of these entities in the portable consumer device with funds transfer processing system 100.

The sending entity 102 possesses and is in communication with the sending entity portable consumer device 103. In an example embodiment, the sending entity portable consumer device 103 may be a credit card, a debit card, a mobile phone, a mobile device, a pre-paid device, a portable computation device running a specialized application, or a portable object that allows a sending entity to effectuate a money transfer. The sending entity 102 may be in possession of the sending entity portable consumer device 103 and may interact with it. In an example embodiment, the sending entity may be a user of the money transfer system, a customer of a merchant that wishes to pay via money transfer, or an individual wishing to transfer funds. Communications between entities in the portable consumer device with transfer processing system 100 may be conducted via the web, a mobile network, an intranet, SMS/IVR, a plain old telephone system, email, APIs, tailored messages, or a communications network.

The sending entity 102 may also communicate with the sending entity issuer 104. In an example embodiment, the sending entity 102 has an account with the sending entity issuer 104. In an example embodiment, the sending entity portable consumer device 103 may have been issued by the sending entity issuer 104 to the sending entity 102. The sending entity 102 may communicate with the money transfer system 106 directly or through the sending entity issuer 104. The sending entity issuer 104 may also communicate with the money transfer system 106. In an example embodiment, the sending entity 102 may initiate a payment request through a webpage, application, or service hosted by the sending entity issuer 104. The sending entity issuer 104 may communicate with the money transfer system 106 and a payment processing network 114 to effectuate the payment request.

The recipient entity 112 possesses and is in communication with the recipient entity portable consumer device 113. In an example embodiment, the recipient entity portable consumer device 113 may be a credit card, a debit card, a mobile phone, a mobile device, a pre-paid device, a portable computation device running a specialized application, or a portable object that allows a sending entity to effectuate a money transfer. The recipient entity 112 may be in possession of the recipient entity portable consumer device 113 and may interact with it.

The recipient entity 112 may also communicate with the recipient entity issuer 110. In an example embodiment, the recipient entity 112 has an account with the recipient entity issuer 110. In an example embodiment, the recipient entity portable consumer device 113 may have been issued by the recipient entity issuer 110 to the recipient entity 112. The recipient entity 112 may communicate with the money transfer system 106 directly or though the recipient entity issuer 110. The recipient entity issuer 110 may also communicate with the money transfer system 106 and with the payment processing network 114. In an example embodiment, the recipient entity 112 may respond to a value transfer message or effectuate the payment request by registering with or responding to the recipient entity issuer 110 or the money transfer system 106.

The money transfer system 106 may communicate with the database 108 to store and retrieve data. The payment processing network 114 may be a transaction network, such as VisaNet. In an example embodiment, the money transfer system 106 may register issuers and account holders. Resulting registration information, such as preferences, verification codes, associated personal account identifiers, and other data may be stored in the database 108. The money transfer system 106 may query the database 108 during the money transfer process to lookup personal account identifiers associated with an alias. The money transfer system 106 may also query the database 108 to verify a verification code.

The money transfer system 106 may communicate with a payment processing network 114. The payment processing network 114 may also communicate with the sending entity issuer 104 and the recipient party issuer 110. For example, the payment processing network 114 may send a money transfer request message, such as a 0200 account funding transaction, to the sending entity issuer 104 to debit funds from the sending entity's 102 account that is associated with the sending entity portable consumer device 103. Similarly, the payment processing network 114 may send a money transfer request message, such as a 0200 original credit transaction, to the recipient entity issuer 110 to deposit funds to the recipient party's 112 account that is associated with the recipient entity portable consumer device 113. An account funding transaction may be a transaction initiated by a sending entity issuer or payment processing network on behalf of the sending entity that results in the debit of the sending entity's account. An original credit transaction may be a transaction that results in a credit to a recipient entity's account.

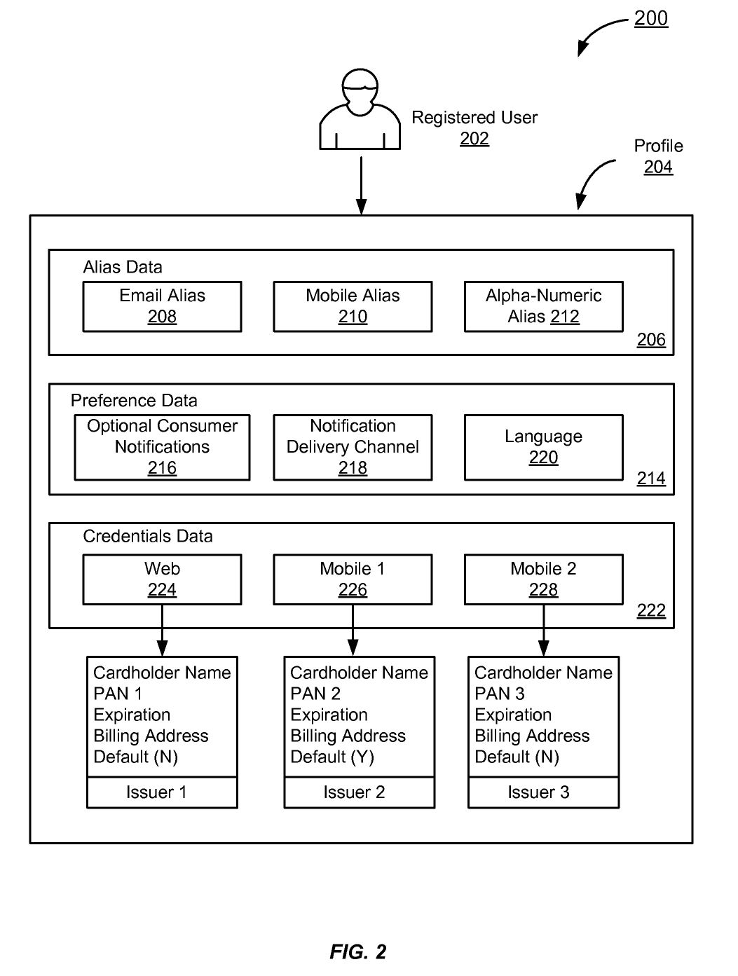

FIG. 2 is a data model of a user profile in a portable consumer device with funds transfer processing system 200, according to an example embodiment. A registered user 202 of a funds transfer processing system, or a money transfer system, may have a profile 204. The profile 204 may be stored in a database accessed by the money transfer system and may contain information supporting money transfer services. A profile 204 may comprise of alias data 206, preference data 214, and credentials data 222.

Alias data 206 describes the aliases associated with the profile 204. In an example embodiment, alias types comprise of email aliases 208, mobile aliases 210, and alpha-numeric aliases 212. An email alias 208 is an alias corresponding to an email address. A mobile alias 210 corresponds to a phone number. An alpha-numeric alias 212 corresponds to an alpha-numeric string, such as a username. In an example embodiment, a user profile may have an alias from each of the alias types. For example, a registered user 202 could have a profile 204 associated with an email address, a mobile phone number, and an alpha-numeric string. In an example embodiment, a registered user 202 can have only one of each type of alias. In another embodiment, a registered user 202 can be associated with a plurality of a particular type of alias, with any combination of alias types. In an example embodiment, a registered user 202 may be associated with only one alias.

Preference data 214 describes the preferences of the registered user 202. Preference data 214 may comprise of optional consumer notifications 216, notification delivery channel 218, and language 220 data. In an example embodiment, optional consumer notifications 216 describe the user's 202 preference for when notifications are to be sent. For example, a user 202 may provide a “yes” or “no” value for whether to receive notification for certain events. The events may include a successful profile activation, a successful account assignment, a successful transfer, a declined claim, or a cancelled transfer. Notification delivery channel 218 describes through what channels a notification should be delivered by. Notification channels may include, but are not limited to, email, SMS, and by letter. The language 220 data describes in which language the user 202 prefers notifications and other data to be presented in. Optional languages may include English, Spanish, and Chinese, among others.

Credentials data 222 may describe data supporting the authentication of a user 202. Credentials data 222 may also comprise of personal account identifier and portable consumer device data. In an example embodiment, credentials data 222 describes a user's 202 account with an issuer. In a further embodiment, credentials data 222 describes a user's 202 account for a single portable consumer device. For example, three credentials, web 224, mobile 1 226, and mobile 2 228 are listed. Each credential describes the portable consumer device/personal account identifier associated with a different issuer. In an example embodiment, each personal account identifier has its own set of credentials data 222 stored with the profile 204. In a further embodiment, each authentication channel for each personal account identifier may also have its own credentials data 222. In a further embodiment, a profile 204 may contain only one credential per issuer per channel. The credentials data 222 may also comprise of portable consumer device data. For example, credentials data 222 for the web 224 channel of issuer 1 describes a cardholder name, a personal account identifier, an expiration, a billing address, and whether the associated portable consumer device is the default for both sending and receiving money transfers. The credentials data 222 for mobile 1 226 recites similar categories of data, but also indicates that this portable consumer device is the default. In an example embodiment, the default status may entail that money transfers to any of the aliases under this profile 204 are sent to the personal account identifier. Credentials data 222 may also describe other data related to an account with an issuer or a portable consumer device.

### II. Method

### A. Web Based Money Transfer

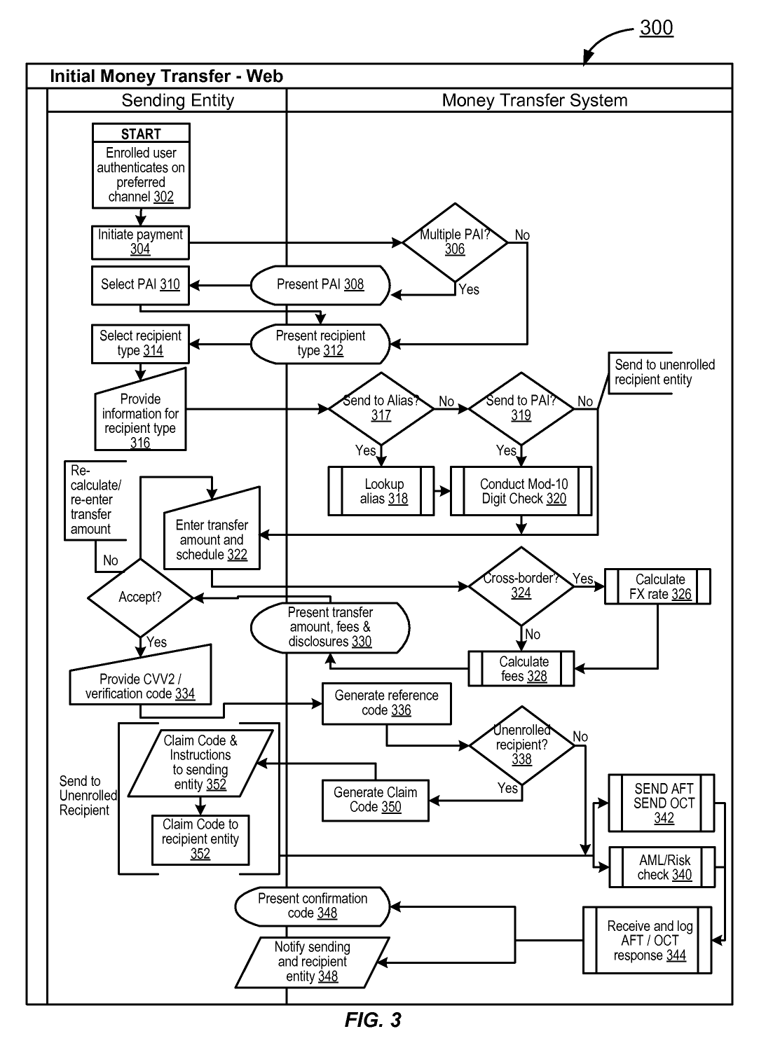

FIG. 3 is process flow of a web based value money transfer process 300, according to an example embodiment. A web based money transfer may be initiated after a sending entity, registered with the money transfer system, authenticates with the money transfer system 302. The authentication may occur on a plurality of authentication channels. After the sending entity authenticates with the money transfer system 302, it may initiate a money transfer by sending a payment request message to the money transfer system 304. In an example embodiment, the payment request message is sent by the sending entity through a webpage hosted by the sending entity issuing bank or the money transfer system. In a further embodiment, the sending entity may be on a merchant webpage which either redirects to or has incorporated connectivity to the money transfer system or the sending entity issuing bank. The payment request message may comprise of a sending entity identifier, such as an alias, a personal account identifier, or a PAN.

Upon receiving the payment request message from the sending entity, the money transfer system determines whether a plurality of personal account identifiers are associated with the sending entity 306. The money transfer system may query a database for the profile of the sending entity and determine whether the credentials data indicates that one or more personal account identifiers are associated with the sending entity. If the money transfer system determines that only one personal account identifier is associated with the sending entity, then the portable consumer device associated with the one personal account identifier is used to fund the money transfer. In an example embodiment, all registered users of the money transfer system, such as the sending entity, have at least one personal account identifier associated with their profile. In a further embodiment, the money transfer system determines only the number of personal account identifiers associated with the issuer that the sending entity authenticated with.

However, if the money transfer system determines that a plurality of personal account identifiers are associated with the sending entity, then the money transfer system will present the plurality of personal account identifiers to the sending entity 308. The personal account identifiers may be presented as funding sources and/or in conjunction with the associated portable consumer device. In an example embodiment, the plurality of personal account identifiers is presented to the sending entity through a webpage, such as a money transfer system hosted webpage, a sending entity issuer bank webpage, or a merchant webpage. The sending entity may receive the plurality of personal account identifiers and select one to fund the money transfer. The sending entity may communicate the selection to the money transfer system. The money transfer system then receives the sending entity selection of one of the plurality of presented payment account identifiers 310. The portable consumer device associated with this one payment account identifier is used to fund the money transfer.

Upon determining the sending entity's payment account identifier and the associated portable consumer device used to fund the money transfer, the money transfer system may present the sending entity a webpage to provide recipient entity data, such as a recipient type, and transfer details 312. In an example embodiment, the recipient types may include alias or personal account identifier. The sending entity may then select one of the recipient types 314 and provide information for the selected recipient type 316. For example, if the sending entity selected the recipient type as “alias” then the sending entity would provide a recipient entity alias. If the sending entity selected the recipient type “personal account identifier,” then the sending entity would provide a personal account identifier and a recipient entity name. The sending entity may then provide the recipient entity data to the money transfer system.

The money transfer system may receive and analyze the sending entity provided recipient entity data. If it is determined that the sending entity provided a registered alias as show by decision block 317, then the money transfer system will look up this alias in a database to derive the associated personal account identifier 318. If the recipient is a personal account identifier, as determined at decision block 319, then no lookup is performed. Security and validity checks, such as a modulus 10 digit check may be performed on the personal account identifier 320. Alternatively, if the recipient type data indicates neither a registered alias nor a registered personal account identifier, but rather an unregistered alias, then the money transfer continues, but notice is sent to the unregistered alias, as described in operation 350.

The money transfer system may prompt the sending entity to provide a transfer amount and a schedule 322. In an example embodiment, the transfer amount is the currency associated with the personal account identifier of the sending entity. In another embodiment, the transfer amount is the currency associated with the personal account identifier of the recipient entity. The sending entity may also provide a schedule for money transfers to be made. For example, a payment schedule may be a one-time payment immediately or for a predetermined future date, e.g., in 3 weeks, on Aug. 8, 2013. In an example embodiment, the payment schedule may define a reoccurring monthly payment on day “x” of the month, for a “y” number of occurrences. For example, a payment can be made on the 15th of every month for 5 months. Similarly, a payment schedule can be made for every “n” day of the week for every week or every two weeks, for a period of “m” weeks. In an example embodiment, reoccurring schedules may be defined on a daily, weekly, or monthly basis, and may occur on particular days or times. In an example embodiment, the reoccurring payments may not be scheduled into the future beyond a certain amount of time, e.g., exceeding one year. The sending entity may communicate the transfer amount and schedule to the money transfer system. In a further embodiment, foreign exchange rates and fees may be different on the actual day of transfer and such variability in rates and fees may be communicated to the sending entity.

The money transfer system may receive and analyze the transfer amount and determine whether any cross border fees or foreign exchange rates apply. In an example embodiment, whether a money transfer is cross border can be derived from the countries in which the issuers of the sending entity and recipient entity personal account identifiers are located 324 and bank identification numbers. The foreign exchange rate may be determined from the respective currencies 326. In an example embodiment, the foreign exchange rate may be derived from a public exchange. In another embodiment, the foreign exchange rate may be determined by the money transfer system or another private system, such as a payment processing network. The money transfer system may provide real time currency conversion. Fees may also be calculated for the money transfer 328. In an example embodiment, fees may be determined from the channel used. Web based money transfers may have a different fee structure than SMS based money transfers. Fees may also depend on other factors, such as the sending entity and recipient entity portable consumer devices, the date, and whether promotions are active. Fees may be fixed rater or a percentage of the transfer amount. Fees may vary by cross border rates, the portable consumer device type, and the relationship between sending entity and recipient entity issuers. The fees may be imposed by the money transfer system, a payment processing network, a sending entity issuer, and a receiving entity issuer. The transfer amount and the fees are the presented to the sending entity 330. In an example embodiment, the transfer amount may be presented in the recipient party currency. If the sending entity rejects the fees and transfer amount, then the money transfer system prompts the sending entity to reenter a new transfer amount 322. If the sending entity approves then the money transfer continues. The sending entity may also be prompted to provide a verification code 334. In an example embodiment, a verification code may be a code associated with the sending entity portable consumer device, such as a CVV2 code.

Upon the sending entity sending approval to the money transfer system of the transfer amount and fees, and the verification code, the money transfer system generates a reference code for the money transfer 336. In an example embodiment, the reference code is derived from the sending entity personal account identifier and the receiving entity personal account identifier. The reference code may be unique to a particular money transfer.

The money transfer system then determines whether the recipient entity is registered with the money transfer system 338. If the recipient entity is registered with the money transfer system, anti-fraud checks may be conducted 340. In an example embodiment, anti-money laundering (AML) checks are conducted against the sending entity personal account identifier and the recipient party personal account identifier. Information about the sending entity and recipient entity may be gathered by the money transfer system across multiple money transfer transactions. In an example embodiment, risk data may be gathered from non-money transfer transactions involving the recipient entity and the sending entity, separately and together, such as transactions through a payment processing network. In an example embodiment, the money transfer system may reject a money transfer if it fails AML or other checks.

The money transfer system may effectuate a money transfer by sending a value transfer debit message to the sending entity issuer 342. In an example embodiment, this message may be sent via a payment processing network on behalf of the money transfer system. The value transfer debit message may be a 0200 account funding transaction (“AFT”) message.

In an example embodiment, the AFT is a transaction designed to supply funds to another account or portable consumer device, such as a credit, prepaid, debit, ATM or online-account, through a money transfer. In an example embodiment, the AFT is paying the sending entity issuer for sending funds to the recipient entity and results in a debit to the sending entity's portable consumer device. The amount of the debit may be the amount of the money transfer plus any fees being charged, such as a money transfer fee or a foreign exchange fee. In an example embodiment, the AFT carries only the account number associated with the portable consumer device of the sending entity. An AFT may also be accompanied by indicators, which allow the sending entity issuer to take appropriate authorization decisions. Indicators include channel information, such as Mail Order/Telephone Order, or internet, and merchant type. A payment processing network, performs currency conversion on AFTs. In a further embodiment, an AFT may comprise the following fields: processing code, merchant type, CAW result code, mail order/telephone order/electronic commerce indicators, and transaction id.

If the sending entity issuer communicates a rejection of the value transfer debit message to the money transfer system, the money transfer system may capture the decline type and data and inform the sending entity through the channel indicated in their profile preferences 344 of a canceled transfer. If the sending entity communicates an acceptance of the value transfer debit message to the money transfer system, then the money transfer system may send a value transfer deposit message to the recipient party issuer. The value transfer deposit message may be a 0200 original credit transaction (“OCT”). In an example embodiment, the AML data, sending entity and recipient entity data, and other fraud/risk indicating data, may be packed with the OCT/value transfer deposit message. If the recipient entity issuer rejects the value transfer deposit message, the money transfer system may capture the decline type and data, and inform the sending entity through the channel indicated in their profile preferences of a canceled transfer 344, 348. The money transfer system will also send a value transfer reversal message to the sending entity issuer to reverse the original value transfer debit message. If the recipient entity issuer approves of the value money deposit message, then the reference code is transmitted to the sending entity and the recipient entity in accordance with their preferences as indicated in their respective profiles 348.

In an example embodiment, An OCT is a clearing and settlement credit transaction designed for use in business applications such as a money transfer system. The OCT may be the transaction used to deliver funds to the recipient account. In an example embodiment, the OCT may be separate from and may take place after the AFT to ensure that payment funds are secured before funds are sent to the recipient. The amount of the OCT may be the amount decided by the sending entity to send in the money transfer. In an example embodiment, the OCT may carry only the account number of the recipient entity without information about the sending entity. In an example embodiment, OCT originating from clearing and settlement connected acquirers are identified by a pre-determined transaction code qualifier value. In a further embodiment, all web-based OCTs contain an Electronic Commerce Indicator. In an example embodiment, a specific Merchant Category Code to indicate financial institutions-merchandise and services is included for both the AFT and OCT.

However, if the money transfer system determines that the recipient entity is not registered with the money transfer system, then the money transfer system generates a claim code 350. The money transfer system then communicates the claim code to the sending entity 352, who in turn communicates it through other means to the recipient entity. In an example embodiment, the money transfer system generates a claim code and communicates it to the recipient entity. In an example embodiment, the unregistered recipient entity is identified through a verifiable alias, such as a phone number or an email address. Instructions for using the claim code may be communicated to the recipient entity through SMS to the telephone number or via email to the email address. The money transfer system may also communicate instructions for the recipient entity to register with the money transfer system. In an example embodiment, the claim code and instructions may be communicated to the sending entity to provide to the recipient entity. If the recipient entity registers with the money transfer system and provides the claim code, then the money transfer continues as if the recipient entity was originally registered. If the recipient entity does not register within a predetermined about of time, then the money transfer may time-out, resulting in the cancellation of the money transfer and the expiration of the claim code. The recipient entity may also reject the money transfer, resulting in notification being sent to the sending entity.

### B. SMS/IVR Based Money Transfer

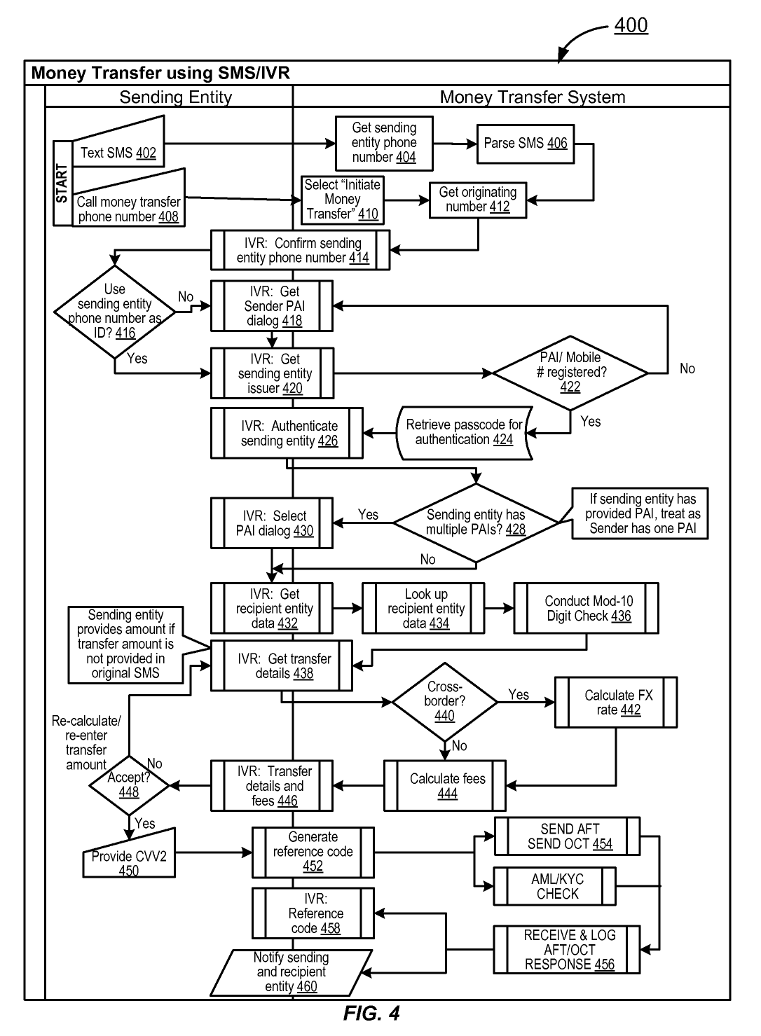

FIG. 4 is a process flow of a short messaging service and interactive voice response based money transfer 400, according to an example embodiment. A sending entity may initiate a money transfer through a SMS/IVR channel or via phone.

A sending entity can initiate a money transfer by sending a payment request message via SMS to the money transfer system 402. The money transfer system may also be contacted through a SMS short code. Upon the money transfer system receiving the payment request message SMS from the sending entity, the money transfer system can obtain the sending entity phone number 404. Additionally, the money transfer system may also parse the received payment request message SMS for additional data, such as a transfer amount of a recipient entity identifier 406. The VMT system may respond to a SMS by calling the sending entity via interactive voice response systems.

Alternatively, a sending entity can initiate a money transfer by placing a telephone call to the money transfer system 408. The sending entity may call via the plain old telephone system, via wireless telephone networks, or via IP based telephony networks. Upon the sending entity connecting via telephone with the money transfer system, the money transfer system may prompt, and the sending entity may indicate via interactive voice response methods, such as by voice or touch tone keypad entries, that they wish to initiate a money transfer 410. The money transfer system may also get the sending entity phone number 412. The money transfer system may automatically determine the sending entity phone number via caller ID. If the money transfer system is unable to automatically determine the sending entity phone number, then the money transfer system may ask the sending entity for their phone number and the sending entity may respond with the phone number.

Interactions from the money transfer system to the sending entity may be conducted audibly via the phone network and may be produced by a IVR system. The sending entity responses may be via interactive voice response methods, such as voice or by touch tone keypad entries.

After the sending entity has initiated a money transfer via SMS 402 or by phone networks 408 and a sending entity phone number has been determined 412, the money transfer system may ask the sending entity if they wish to use the sending entity phone number as a sending entity alias 414. If the sending entity confirms that they wish to use the sending entity phone number as their alias 416, then the sending entity phone number is used as the sending entity alias. If the sending entity responds that they do not wish to use the sending entity phone number as the sending entity alias 416, then the money transfer system will query the sending entity for a sending entity personal account identifier 418.

Upon the money transfer system receiving the sending entity personal account identifier from the sending entity or affirmation to use the sending entity phone number as the sending entity alias, the money transfer system will ask the sending entity for the sending entity issuer associated with the provided personal account identifier or sending entity alias 420. Upon receiving from the sending entity identifier the sending entity issuer, the money transfer system then determines if the provided personal account identifier or sending entity alias is registered with the money transfer system 422. If the sending entity identifier or sending entity alias is not registered with the money transfer system, the money transfer system queries the sending entity for a sending entity personal account identifier 418. If the money transfer system determines that the personal account identifier or sending entity alias is registered 422, then the money transfer system will retrieve a pass code for the respective identifier from a database and prompt the sending entity to authenticate by responding with a matching pass code 426. In an example embodiment, the sending entity may have a unique pass code for a mobile authentication channel, such as using SMS/IVR techniques.

After the sending entity provides a valid pass code and authenticates, the money transfer system may then determine if a plurality of personal account identifiers is associated with the sending entity. If the sending entity has already provided a personal account identifier, or the provided sending entity alias is associated with only one personal account identifier, then that personal account identifier is used for the money transfer. Alternatively, if a plurality of personal account identifiers are associated with the sending entity 428, then the money transfer system may prompt the sending entity to select one of the plurality of personal account identifiers 430.

Once the sending entity provides a single personal account identifier, the money transfer system may then prompt the sending entity to provide recipient entity data 432. Recipient entity data may be a recipient entity identifier, such as a recipient entity alias or a recipient entity personal account identifier. If the sending entity provided the recipient entity identifier as part of the original payment request message SMS 402, this operation is fulfilled. Otherwise, the sending entity provides a recipient entity identifier. The money transfer system may then look up the recipient entity identifier and determine whether it is registered with the money transfer system 434. If the money transfer system determines that the recipient entity is registered with the money transfer system 434, then the money transfer system performs various fraud checks. If the recipient entity has a plurality of personal account identifiers associated with it, a default personal account identifier may be used in the money transfer transaction. In an example embodiment, the money transfer system performs a modulus 10 digit check 436 on the sending entity personal account identifier and the recipient entity personal account identifier.

The money transfer system may continue with the money transfer if fraud checks are passed. The money transfer system may then prompt the sending entity for transfer details 438. Transfer details may comprise of a transfer amount. In an example embodiment, the transfer amount is in the currency associated with the personal account identifier of the sending entity. In another embodiment, the transfer amount is in the currency associated with the personal account identifier of the recipient entity. If the transfer amount was already provided in the original payment request message SMS, then this operation is skipped.

The money transfer system may analyze the transfer amount and determine whether any cross border fees or foreign exchange rates apply. In an example embodiment, whether a money transfer is cross border can be derived from the countries of the issuers associated with the sending entity and recipient entity personal account identifiers 440. The foreign exchange rate may be determined from the respective currencies 442. In an example embodiment, the foreign exchange rate may be derived from a public exchange. In another embodiment, the foreign exchange rate may be determined by the money transfer system or another private system, such as a payment processing network. Fees may also be calculated for the money transfer 444. In an example embodiment, fees may be determined from the channel used. Fees may also depend on other factors, such as the sending entity and recipient entity portable consumer device, the date, and whether promotions are active. The fees may be imposed by the money transfer system, a payment processing network, a sending entity issuer, and a receiving entity issuer. The transfer amount and the fees are then communicated to the sending entity 446. In an example embodiment, the transfer amount may be presented in the recipient entity currency. If the sending entity rejects the fees and transfer amount 448, then the money transfer system prompts the sending entity to reenter a new transfer amount 438. If the sending entity approves then the money transfer continues 448. The sending entity may also be prompted to provide a verification code 450. In an example embodiment, a verification code may be a code associated with the sending entity portable consumer device, such as a CVV2 code.

Upon the sending entity sending approval to the money transfer system of the transfer amount and fees and the verification code, the money transfer system generates a reference code for the money transfer 452. In an example embodiment, the reference code is derived from the sending entity personal account identifier and the receiving entity personal account identifier. The reference code may be unique to a particular money transfer.

The money transfer system may effectuate a money transfer by sending a value transfer debit message to the sending entity issuer 454. In an example embodiment, this message may be sent via a payment processing network on behalf of the money transfer system. The value transfer debit message may be a 0200 account funding transaction (“AFT”) message.

If the sending entity issuer communicates a rejection of the value transfer debit message to the money transfer system, the money transfer system may capture the decline type and data and inform the sending entity through the channel indicated in their profile preferences 456. If the sending entity communicates an acceptance of the value transfer debit message to the money transfer system, then the money transfer system may send a value transfer deposit message to the recipient party issuer 454. The value transfer deposit message may be a 0200 original credit transaction (“OCT”). In an example embodiment, the AML data, sending entity and recipient entity data, and other fraud/risk indicating data, may be packed with the OCT/value transfer deposit message. If the recipient entity issuer rejects the value transfer deposit message, the money transfer system may capture the decline type and data, and inform the sending entity through the channel indicated in their profile preferences of a canceled transfer. The money transfer system will also send a value transfer reversal message to the sending entity issuer to reverse the original value transfer debit message. If the recipient entity issuer approves of the value money deposit message, then the reference code and notification may be transmitted to the sending entity and the recipient entity in accordance with their preferences as indicated in their respective profiles 458, 460.

### C. Agent Supported Money Transfer

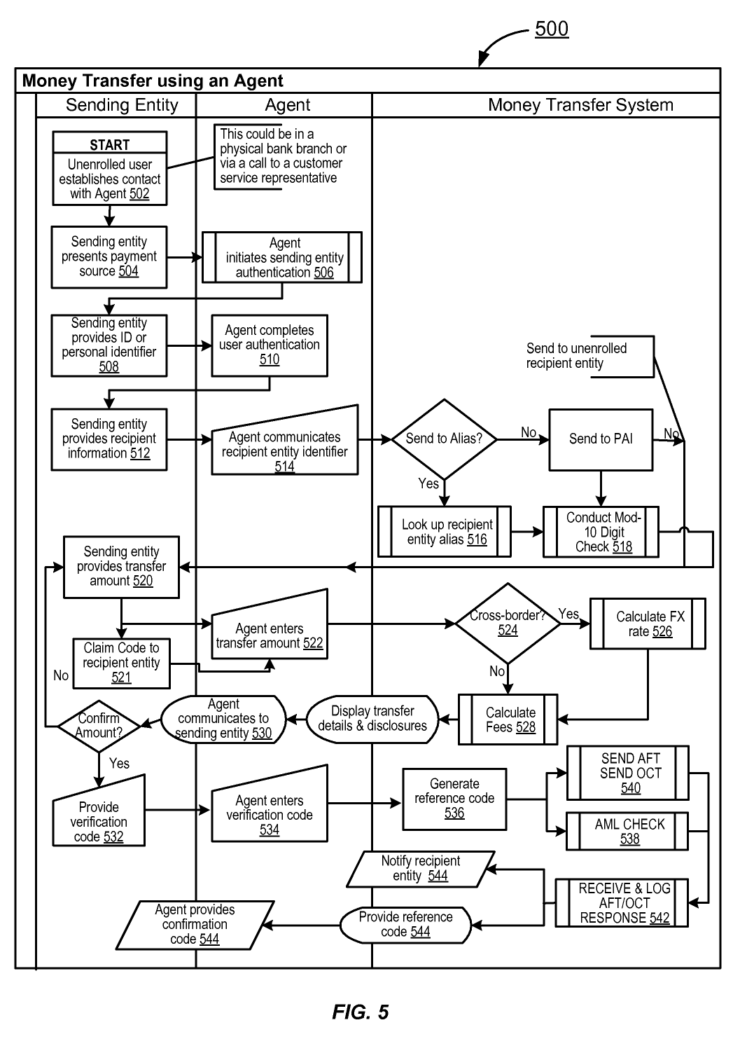

FIG. 5 is a process flow of an agent supported money transfer, according to an example embodiment. A sending entity may initiate a money transfer by visiting an agent. An agent may have access to money transfer services. The agent may be an employee of a bank. Agent supported money transfers provide unregistered sending entities and those without access to the web or SMS/telephones, a method of sending a money transfer.

An agent supported money transfer begins when a sending entity establishes contact with an agent 502. Contact may be in person, via teleconference, via a telephone call to a customer service representative, or other methods where an agent can interact with a sending entity. The sending entity presents a payment source to the agent 504. A funding source may be a portable consumer device, such as a credit card, a debit card, or a pre-paid card. An agent may verify the funding source and authenticate the sending entity 506. To authenticate a sending entity, an agent may ask for physical identification, such as a driver's license or a government issued ID card with a photo. Alternatively, the sending entity may provide personal identifiers, such as a PIN or personal information, such as the last four digits of their social security number. After the sending entity presents identification 508 the agent determines whether the sending entity is authenticated 510.

Next, the sending entity may communicate recipient entity identifier to the agent 512. The recipient entity identifier may be an alias or a personal account identifier, such as a PAN. The sending entity may also provide ancillary recipient entity data, such as the recipient entity's name. The agent receives the recipient entity identifier and ancillary data and communicates it to a money transfer service 514. The agent may interact with the money transfer service through the web, via SMS/IVR, or via a terminal at the bank.

The money transfer system may analyze the agent provided recipient entity data. If the agent provided a registered alias, then the money transfer system will lookup this alias in a database to derive the associated personal account identifier 516. If the recipient is a personal account identifier then no lookup is performed. Security and validity checks, such as a modulus 10 digit check may be performed on the personal account identifier in operation 518. Alternatively, if the recipient type data indicates neither a registered alias nor a registered personal account identifier, then the money transfer continues, but notice is sent to the un-registered recipient, as described in operation 521 with a claim code.

Next, the sending entity provides a transfer amount to the agent 520. The agent then provides the transfer amount to the money transfer system 522. In an example embodiment, the transfer amount is with respect to the currency associated with the personal account identifier of the sending entity. In another embodiment, the transfer amount is with respect to the currency associated with the personal account identifier of the recipient entity.

The money transfer system may receive and analyze the transfer amount and determine whether any cross border fees or foreign exchange rates apply. In an example embodiment, whether a money transfer is cross border can be derived from the countries of the issuers associated with the sending entity and recipient entity personal account identifiers 524. The foreign exchange rate may be determined from the respective currencies 526. In an example embodiment, the foreign exchange rate may be derived from a public exchange. In another embodiment, the foreign exchange rate may be determined by the money transfer system or another private system, such as a payment processing network. Fees may also be calculated for the money transfer 528. In an example embodiment, fees may be determined from the channel used. Fees may also depend on other factors, such as the sending entity and recipient entity portable consumer device, the date, and whether promotions are active. The fees may be imposed by the money transfer system, a payment processing network, a sending entity issuer, the agent's bank, and a receiving entity issuer. The transfer amount and the fees are the presented to agent which can communicate it to the sending entity 530. In an example embodiment, the transfer amount may be presented in the recipient entity currency. If the sending entity rejects the fees and transfer amount, then the money transfer system prompts the sending entity to reenter a new transfer amount 520. If the sending entity approves then the money transfer continues. The sending entity may also be prompted to provide a verification code 532. In an example embodiment, a verification code may be a code associated with the sending entity portable consumer device, such as a CVV2 code. The sending entity may provide the verification code to the agent which provides it to the money transfer system 534.

Upon the agent sending approval to the money transfer system of the transfer amount and fees and the verification code, the money transfer system generates a reference code for the money transfer 536. In an example embodiment, the reference code is derived from the sending entity personal account identifier and the receiving entity personal account identifier. The reference code may be unique to a particular money transfer.

Anti-fraud checks may be conducted 538. In an example embodiment, anti-money laundering (AML) checks are conducted against the sending entity personal account identifier and the recipient party personal account identifier. Information about the sending entity and recipient entity may be gathered by the money transfer system across multiple money transfer transactions. In an example embodiment, risk data may be gathered from non-money transfer transactions involving the recipient entity and the sending entity, separately and together, such as transactions through a payment processing network. In an example embodiment, the money transfer system may reject a money transfer if it fails AML or other checks.

The money transfer system may effectuate a money transfer by sending a value transfer debit message to the sending entity issuer 540. In an example embodiment, this message may be sent via a payment processing network on behalf of the money transfer system. The value transfer debit message may be a 0200 account funding transaction (“AFT”) message.

If the sending entity issuer communicates a rejection of the value transfer debit message to the money transfer system, the money transfer system may capture the decline type and data and inform the sending entity through the channel indicated in their profile preferences. If the sending entity communicates an acceptance of the value transfer debit message to the money transfer system, then the money transfer system may send a value transfer deposit message to the recipient party issuer. The value transfer deposit message may be a 0200 original credit transaction (“OCT”). In an example embodiment, the AML data, sending entity and recipient entity data, and other fraud/risk indicating data, may be packed with the OCT/value transfer deposit message. If the recipient entity issuer rejects the value transfer deposit message, the money transfer system may capture the decline type and data, and inform the sending entity through the channel indicated in their profile preferences of a canceled transfer 542. The money transfer system will also send a value transfer reversal message to the sending entity issuer to reverse the original value transfer debit message. If the recipient entity issuer approves of the value money deposit message, then the reference code is transmitted to the agent which provides it to the sending entity 544.

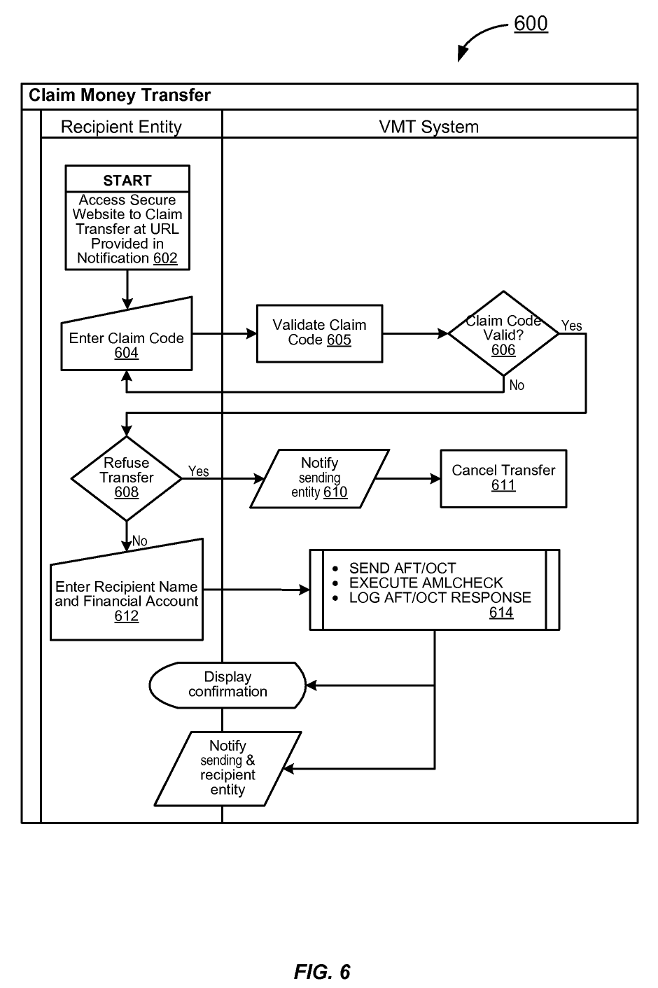

FIG. 6 is a claim money transfer process 600, according to an example embodiment. An unregistered recipient entity may receive a claim code along with a notification message with instructions for the recipient entity to register with the money transfer system to claim a money transfer. At operation 602 an unregistered recipient entity accesses a website to register with the money transfer system. The website may be operated by the money transfer system or an issuer. In an example embodiment, the URL of the website may be included in the notification message sent by the money transfer system. At operation 604 the recipient entity enters the claim code, along with other requested information, into the website and submits it. A validation process is then initiated 605. If the money transfer system determines that the claim code is invalid 606 or has expired, then the recipient entity is prompted again to enter a claim code 604.

If the money transfer system determines that the claim code is valid 606, then the website prompts the recipient entity if they wish to accept the money transfer 608. If the recipient entity refuses the money transfer, then the money transfer system notifies the sending entity of the cancellation of the money transfer 610 and then cancels the money transfer 611. If the recipient entity indicates they wish to accept the money transfer 608, then the money transfer system prompts the recipient entity to enter registration data. Registration data may comprise the recipient entity's name and financial account data. In an example embodiment, financial account data may correspond to consumer and business debit or credit accounts, a portable consumer device, or reloadable pre-paid credit accounts. Upon receipt of the registration data, the money transfer system continues processing the money transfer, including steps of sending a value transfer debit/deposit message to issuers, executing AML checks, and logging issuer responses 614.

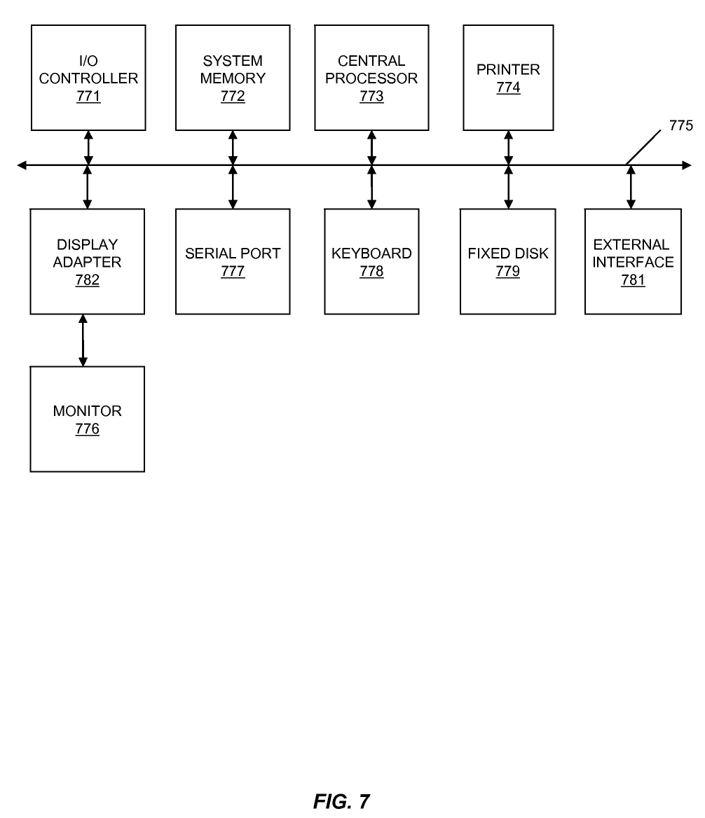

FIG. 7 is a diagram of a computer apparatus, according to an example embodiment. The various participants and elements in the previously described system diagrams (e.g., the money transfer system, database, payment processing network, sending entity issuer, recipient entity issuer, etc. in FIGS. 1, 2) may use any suitable number of subsystems in the computer apparatus to facilitate the functions described herein. Examples of such subsystems or components are shown in FIG. 7. The subsystems shown in FIG. 7 are interconnected via a system bus 775. Additional subsystems such as a printer 774, keyboard 778, fixed disk 779 (or other memory comprising computer-readable media), monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer-readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Embodiments of the money transfer system may provide several advantages over existing systems. A money transfer system facilitates card to card, or portable consumer device to portable consumer device, money transfers. Existing customers and merchants are aware of and trust these devices, and may already own a portable consumer device and associated POS hardware. The widespread use and support of portable consumer devices makes embodiments of the invention convenient for users.

In addition, the money transfer system may also provide, singularly, or together with a payment processing network, such as VisaNet, security and anti-fraud measures. Secure and reliable infrastructure for portable consumer devices already exists. Anti fraud, transaction velocity, and other checks are conducted to ensure valid transactions. The money transfer system and associated payment processing network, also provide secure transactions, so that fraudulent transactions or compromise of account data are avoided.

What is claimed is:

1. A method comprising:
receiving a payment request message from a sending entity;
determining via a processor if a plurality of personal account identifiers are associated with the sending entity and if a plurality of personal account identifiers are associated with the sending entity then providing the plurality of personal account identifiers to the sending entity and receiving a single personal account identifier from the sending entity, wherein the personal account identifiers are associated with a portable consumer device;
receiving a recipient entity identifier and transfer details from the sending entity, wherein the recipient entity identifier is an alias or a personal account number of a recipient entity and the transfer details comprise a transfer amount;
receiving a portable consumer device verification code from the sending entity;
generating a reference code from the one personal account identifier and the recipient entity identifier; and
providing the reference code to the sending entity.

2. The method of claim 1 further comprising sending a value transfer debit message to a sending entity issuer.

3. The method of claim 2 further comprising sending a value transfer deposit message to a recipient entity issuer after the sending entity issuer approves of the value transfer debit message.

4. The method of claim 1 further comprising determining that the recipient entity identifier is an unregistered alias and providing a claim code to the sending entity to communicate to the recipient entity.

5. The method of claim 4 wherein the unregistered alias is registered upon receiving from the recipient entity the claim code and personal account information associated with a portable consumer device of the recipient entity.

6. The method of claim 5 wherein a value transfer deposit message is sent to a recipient entity issuer and a value transfer debit message is sent to a sending entity issuer after the recipient entity registers.

7. The method of claim 1 wherein a transfer fee is processed with the transfer amount so that the sending entity is debited the transfer amount plus the transfer fee.

8. The method of claim 7 further comprising providing the transfer amount and the transfer fee to the sending entity and providing the reference code to the sending entity only if approval of the transfer fee is received from the sending entity.

9. The method of claim 1 wherein the payment request message is sent via short message service and wherein the payment request message is parsed for a sending entity phone number and a recipient entity identifier, and further wherein it is determined whether the plurality of personal account identifiers is associated with the sending entity phone number.

10. A value transfer server comprising:
a processor; and
a computer-readable non-transitory medium coupled to the processor, the computer readable medium comprising code executable by the processor for implementing a method comprising
receiving a payment request message from a sending entity;
determining via a processor if a plurality of personal account identifiers are associated with the sending entity and if a plurality of personal account identifiers are associated with the sending entity then providing the plurality of personal account identifiers to the sending entity and receiving a single personal account identifier from the sending entity, wherein the personal account identifiers are associated with a portable consumer device;
receiving a recipient entity identifier and transfer details from the sending entity, wherein the recipient entity identifier is an alias or a personal account number of a recipient entity and the transfer details comprise a transfer amount;
receiving a portable consumer device verification code from the sending entity;
generating a reference code from the one personal account identifier and the recipient entity identifier; and
providing the reference code to the sending entity.

11. The system of claim 10, further comprising a sending entity issuer which receives a value transfer debit message.

12. The message of claim 10, further comprising a recipient entity issuer which receives a value transfer deposit message.

13. A non-transitory computer readable medium comprising code executable by a processor, for implementing a method comprising:
receiving a payment request message from a sending entity;
determining via a processor if a plurality of personal account identifiers are associated with the sending entity and if a plurality of personal account identifiers are associated with the sending entity then providing the plurality of personal account identifiers to the sending entity and receiving a single personal account identifier from the sending entity, wherein the personal account identifiers are associated with a portable consumer device;
receiving a recipient entity identifier and transfer details from the sending entity, wherein the recipient entity identifier is an alias or a personal account number of a recipient entity and the transfer details comprise a transfer amount;
receiving a portable consumer device verification code from the sending entity;
generating a reference code from the one personal account identifier and the recipient entity identifier;
providing the reference code to the sending entity.

14. The computer readable medium of claim 13 further comprising the operation of sending a value transfer debit message to a sending entity issuer.

15. The computer readable medium of claim 14 further comprising the operation of sending a value transfer deposit message to a recipient entity issuer after the sending entity issuer approves of the value transfer debit message.

16. The computer readable medium of claim 13 further comprising the operation of determining that the recipient entity identifier is an unregistered alias and providing a claim code to the sending entity to communicate to the recipient entity.

17. The computer readable medium of claim 16 wherein the unregistered alias is registered upon receiving from the recipient entity the claim code and personal account information associated with a portable consumer device of the recipient entity.

18. The computer readable medium of claim 17 wherein a value transfer deposit message is sent to a recipient entity issuer and a value transfer debit message is sent to a sending entity issuer after the recipient entity registers.

19. The computer readable medium of claim 13 wherein a transfer fee is processed with the transfer amount so that the sending entity is debited the transfer amount plus the transfer fee.

20. The computer readable medium of claim 13 further comprising the operation of providing the transfer amount and the transfer fee to the sending entity and providing the reference code to the sending entity only if approval of the transfer fee is received from the sending entity.
